(19) United States
(12) Patent Application Publication
(10) Pub. No.: US 2022/0099276 A1
(43) Pub. Date: Mar. 31, 2022

(54) LIQUID DIVERTING FIXTURE ASSEMBLIES AND METHODS FOR THE SAME

(71) Applicant: L70 Technologies, LLC, Naples, FL (US)

(72) Inventor: Kent Vaughan Shields, Chaska, MN (US)

(21) Appl. No.: 17/422,071

(22) PCT Filed: Jan. 11, 2020
(86) PCT No.: PCT/US2020/013247

§ 371 Date: Jul. 9, 2021

Related U.S. Application Data
(60) Provisional application No. 62/791,402, filed on Jan. 11, 2019.

(51) Int. Cl. F21V 15/01; F21V 31/03

(52) U.S. Cl. CPC F21V 15/01; F21V 31/03

(57) ABSTRACT

In some examples, a liquid diverting fixture assembly includes a housing that optionally includes one or more sensitive components therein. In an example, at least one tenon orifice extends through the housing, and the tenon orifice is configured for reception of a tenon therein. A liquid diverting system is optionally included within the housing. In an example, the liquid diverting system includes a ring diverter configured for coupling along the tenon. The ring diverter is optionally positioned between the at least one tenon orifice and the one or more sensitive components. In some examples, the ring diverter includes a diversion skirt having a skirt profile coincident to at least the tenon orifice.

### CLAIM OF PRIORITY

This patent application claims the benefit of priority, under 35 U.S.C. Section 119(e), to Kent Vaughan Shields U.S. Patent Application Ser. No. 62/791,402, entitled “Liquid Diverting Fixture Assemblies And Methods For The Same,” filed on Jan. 11, 2019 (Attorney Docket No. 4432.002PRV), which is hereby incorporated by reference herein in its entirety.

### CROSS-REFERENCE TO RELATED PATENT DOCUMENTS

This patent application is also related to U.S. patent application Ser. No. 15/040,342; FIXTURE MOUNT ASSEMBLY; filed on Feb. 10, 2016.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Energy Management Collaborative, LLC; of Plymouth Minn., USA. All Rights Reserved.

### BACKGROUND

Fixtures, including fixture mounting assemblies, assemblies of light elements, sensor elements, audio elements (e.g., speakers) or the like, are in some examples installed and maintained in outdoor environments. Weather events, high and low pressure washing or cleaning, and exposure can corrode or initiate failure in sensitive components of the fixtures, such as electronic components, sensor elements or the like.

These assemblies are, in some examples, constructed with seals, gaskets, O-rings (referred to generally as seals) or the like to isolate the interiors of the assemblies and sensitive components therein form moisture. The seals occupy openings in the assembly housing or are interposed between features of the assembly housing to provide a sealed enclosure for the components therein and accordingly prevent the ingress of moisture.

In other examples, the sensitive components of the assemblies are constructed robustly. For instance, the sensitive components are packed in weather resistant casings or are constructed with materials that are resistant to corrosion, electrical shorting or the like. The robust components resist weather-based failure caused by the ingress of moisture into the assembly, for instance through the housing of the fixture.

### OVERVIEW

The present inventors have recognized, among other things, that a problem to be solved includes minimizing damage caused by the ingress and retention of moisture within fixture assemblies including, but not limited to, light, sensor and audio fixtures, fixture mounting assemblies or the like. In some examples, fixture assemblies are constructed with seals intended to prevent the ingress of moisture and accordingly isolate sensitive components from the weather. In practice seals fail over time and allow the ingress of moisture. Alternatively, condensation builds within the fixture assemblies and cannot escape because the seals are unique to the assemblies, have tight tolerances and prevent egress of the condensation. The accumulated water, in these examples, initiates corrosion and failure of the components of the fixture assemblies.

In other examples, robust components are used in fixture assemblies that are resistant to weather-based wear including corrosion and electrical shorting caused by moisture. Moisture in the fixture assemblies may, in some examples, corrode even robust components over the specified operational lifetime of the assemblies.

The present subject matter helps provides a solution to this problem with a liquid diverting fixture assembly. The assembly includes a liquid diverting system within the housing of the assembly. A ring diverter, configured for coupling along a tenon of a fixture, is positioned between a tenon orifice and one or more sensitive components. The ring diverter includes a diversion skirt having, in one example, a skirt profile that occludes the tenon orifice not otherwise already filled with the tenon. Moisture delivered through the tenon orifice (e.g., wind driven rain passing between the orifice walls and the tenon, cleaning fluids or the like) is intercepted by the ring diverter and directed along a diversion skirt away from sensitive components toward one or more drain reservoirs. The drain reservoirs include one or more drains that communicate captured liquid to the exterior of the housing (e.g., by gravity).

The liquid diverting system does not use seals that are prone to leaking or the retention of condensation in the assembly. Instead, the liquid diverting system allows the assembly to remain open to vent condensation as it accumulates in the assembly. Further, the liquid diverting system provides one or more intercepting features (e.g., ring diverters, isolation flanges or the like, described herein) proximate to portions of the assembly that are prone to the ingress of moisture including, but not limited to, orifices, tenon orifices, interior or exterior assemblies and mixed interior and exterior assemblies. The skirt profile of the ring diverter is interposed between the assembly exterior and sensitive components and thereby intercepts moisture, such as wind driven rain, pressurized fluids or the like before reaching the components. Further, the diversion skirt delivers the intercepted liquid away from the components to one or more drains that are isolated from the components.

This overview is intended to provide an overview of subject matter of the present patent application. It is not intended to provide an exclusive or exhaustive explanation of the disclosure. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a liquid diverting fixture assembly and a plurality of fixtures.

FIG. 2 is a detailed perspective view of the liquid diverting fixture assembly of FIG. 1.

FIG. 3 is an interior view of the liquid diverting fixture assembly of FIG. 1.

FIG. 4 is a perspective view of one example of a fixture including a tenon.

FIG. 5 is a cross sectional view of the fixture shown in FIG. 4 including another example of a liquid diverting fixture assembly.

FIG. 6A is a perspective view of one example of a ring diverter.

FIGS. 6B-6E are top views of example ring diverters having different profiles.

FIG. 7 is a schematic view showing an example ring diverter in a coincident position relative to a tenon orifice.

FIG. 8A is a plan view of one example of a punch out sheet including a plurality of ring diverters with different profiles.

FIG. 8B is a plan view of another example of a punch out sheet including a plurality of ring diverters with different profiles.

FIG. 9 block diagram of one example of a method of operation.

### DETAILED DESCRIPTION

In some examples, a liquid diverting fixture assembly includes a housing that optionally includes one or more sensitive components therein. In an example, at least one tenon orifice extends through the housing, where the tenon orifice is configured for reception of a tenon therein. A liquid diverting system is optionally included within the housing. The liquid diverting system can include a ring diverter configured for coupling along the tenon. The ring diverter is optionally positioned between the at least one tenon orifice and the one or more sensitive components. Additionally, the liquid diverting system optionally includes a drain reservoir recessed from the one or more sensitive components. In some examples, the diversion skirt extends toward the drain reservoir. A drain is optionally in communication with the drain reservoir. More specific examples are discussed below with respect to the figures.

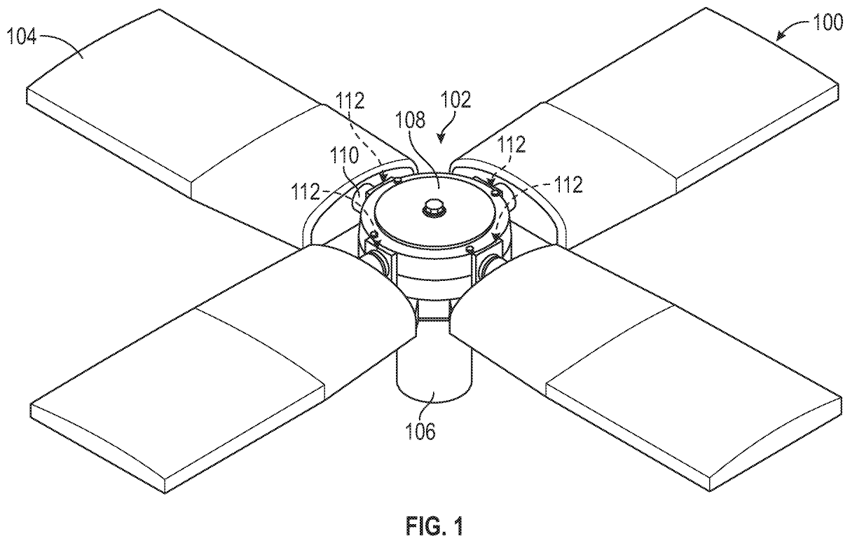

FIG. 1 is a top perspective view of a liquid diverting fixture assembly 100 and a plurality of fixtures 104. The fixture assembly 100 includes a fixture mount 102 and optionally includes a support 106 (e.g., such as a light pole). The fixtures 104 can each include a tenon 110. The fixture mount 102 optionally includes a cover 108 and liquid diverting assemblies 112.

The fixtures 104 include, but are not limited to, lighting devices configured to emit light therefrom, such as for illuminating an indoor or outdoor space (such as a sidewalk or surface lot). The fixtures 104 optionally include one or more lighting devices therein, such as a bulb or light emitting diode (LED). The fixtures 104 in other examples, include, but are not limited to, audio fixtures, instrumentation fixtures, sensor fixtures, or the like. The tenons 110 are secured to housings of the fixtures 104 and the tenons, as part of the assembly 100, are configured to support the respective fixtures 104.

The fixture mount 102 can include a housing and one or more orifices configured to receive the tenons 110 therein to support the plurality of fixtures 104. The fixture mount 102 can also include supports therein for securing the tenons 110, and therefore the fixtures 104, to the fixture mount 102.

The support 106 shown in FIG. 1 can include one or more work pieces including, but not limited to, light posts, light poles, utility posts, poles, or the like. The work pieces can be configured to position the fixtures 104 at a desired position, for instance elevated above an area to be lit, an area to be observed, an area to provide a broadcast to, or the like.

The plurality of fixtures 104 can each be coupled with the fixture mount assembly 102 provided between the fixtures 104 and the support 106. The fixture mount assembly 102 can provide a component to allow for quick, reliable, and robust coupling of the fixtures 104 to the support 106 with little to no preparation of the support 106 (e.g., mapping a pattern of fasteners or holes, drilling or machining the support or the like). Even where the style of the fixtures 104 vary (e.g., have differing installation footprints shapes, sizes, functions or the like) the fixture mount assembly 102 can provide an interface to readily couple the fixtures 104 with the support 106.

The liquid diverting assemblies 112 can be positioned within the fixture mount 102 near the orifices that are configured to receive the tenons. As discussed in further detail below, the liquid diverting assemblies 112 are configured to minimize (e.g., decrease or eliminate) moisture ingress at the orifices of the fixture mount 102 and in other examples are configured to divert moisture from the fixture mount 102 to minimize corrosion and exposure of sensitive components within the fixture mount 102 to moisture or fluid, such as wind-driven rain, water vapor, condensed humidity or the like, to help limit component failure.

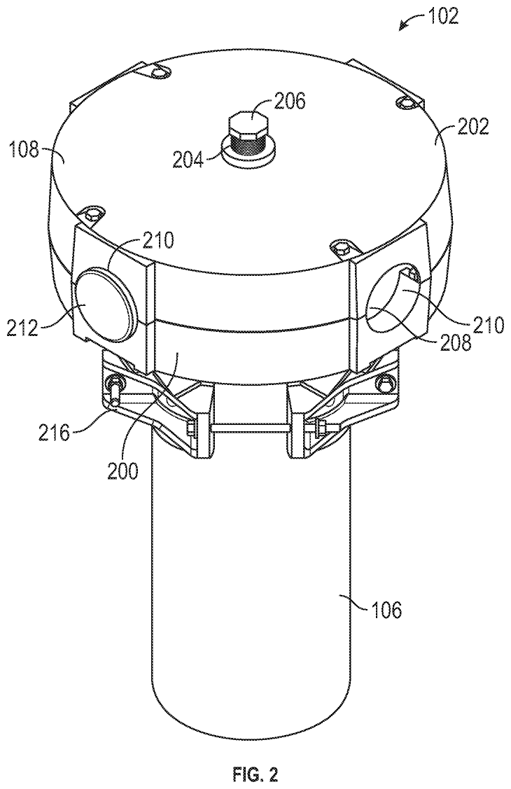

FIG. 2 shows one example of the fixture mount assembly 102 with the fixtures 104 removed for illustration purposes. The fixture mount assembly 102 can include the fixture mount 108 and a grasping clamp 216 coupled with a mount body 200 of the fixture mount 108. The grasping clamp 216 can be coupled around a support, such as the support 106 shown in FIG. 1 and duplicated here in FIG. 2. More specifically, the grasping clamp 216 can include a plurality of features configured to facilitate coupling of the fixture mount assembly 102 to the support 106 and optionally minimize other forms of fastening between the fixture mount assembly 102 and the support 106 (e.g., with fasteners such as bolts, screws, rivets or the like).

The fixture mount 108 can include a mount body 200 having a body cover 202. The body cover 202 can be removable relative to a remainder of the mount body 200 to facilitate access to the interior of the fixture mount 108. In another example, the separation between the body cover 202 and the remainder of the mount body 200 is at a different location of the mount 108. For example, the separation is positioned above the fixture ports 210 and the ports 210 extend continuously through the remainder of the mount body 200 and are not split between the body 200 and the body cover 202. Optionally, a wiring cavity is provided within the fixture mount 108 to easily route and direct one or more of wiring, wiring harnesses, cables, instrumentation or the like through the fixture ports 210 to each of the fixtures 104 shown in FIG. 1 as well as through the support 106 shown in FIG. 2. In an example, the writing cavity is a junction box.

As shown in FIG. 2, an instrument port 204 can provided in the body cover 202. In one example, the instrument port 204 includes a port plug or instrument port plug 206 sized and shaped for reception within the instrument port 204. Where desired, the installer may remove the instrument port plug 206 and install one or more instruments within the instrument port 204 for instance for communication with the fixtures such as the fixtures 104 shown in FIG. 1. One example of an instrument positioned within the instrument port 204, or extending through the instrument port, is a photosensitive cell (photo cell) in communication with one or more of the fixtures 104 to provide an external light operated switch the fixtures 104 where, in one example, the fixtures are light fixtures. Where an instrument is not used with the fixture mount assembly 102, the instrument port plug 206 can be provided through the instrument port 204 to close the fixture mount 108.

As further shown in FIG. 2 and previously mentioned herein, one or more fixture ports 210 can be provided around the fixture mount 108. As shown in FIG. 2, four fixture ports are provided at approximately ninety-degree positions around the mount 108. In other examples, one or more fixture ports 210 are provided with the fixture mount 108 (e.g., the fixture mount 108 includes one, two, three or more fixture ports 210). Although the fixture ports 210 are shown at a consistent elevation and position around the mount body 200, in other examples the fixture ports 210 are provided vertically and horizontally around the fixture mount 108 according to the needs for the particular application of the fixtures 104 shown in FIG. 1. For instance, fixture ports 210 can be formed at varying locations (vertically) along the mount body 200 to maximize the use of space of the body or position fixtures such as instrument fixtures, above or below other fixtures, such as audio or light fixtures. In other examples, the fixtures can be provided at varied intervals, in a cluster or the like (e.g., horizontally around the mount body 200). For instance, a cluster of fixture ports 210 is provided along a portion of the mount body 200 where the installer desires to direct the associated fixtures in a direction or arc (e.g., toward an athletic field, away from homes, or the like).

As will be described herein, one or more fixture anchors 208 are provided around the fixture mount 108 corresponding to each of the fixture ports 210. In one example, the fixture anchors 208 include each of the respective fixture ports 210 as well as fixture clamps provided within the fixture mount 108 to securely couple with one or more fixtures 104 including one or more fixture adapters (described herein) used for coupling fixtures 104 with the fixture mount assembly 102. As described herein, set screws or other fasteners are optionally provided at the fixture ports within the fixtures or the like to anchor the fixtures with the components of the fixture mount assembly 102. As will be described herein, the fixture anchors 208 provide both lateral and translational retention and support of the fixtures 104 and the fixture adapters relative to the fixture mount assembly 102 and the support 106.

In other examples, where the fixture mount assembly 102 includes a plurality of fixture ports 210 but fewer than the total number of fixture ports 210 are used, one or more port plugs 212 are selectively positioned in the unused fixture ports 210 to provide and maintain a closed environment within the mount body 200. The mount body 200 of the fixture mount 108 thereby conceals the interior of the assembly 102 and protects sensitive components including, but not limited to, wiring, wiring harnesses, cables, instrumentation or the like. With the body cover 202 in place along the remainder of the mount body 200 and one or more fixtures 104 or port plugs 212 coupled with the fixture mount assembly 102 the assembly 102 robustly couples the fixtures in place while at the same time providing a concealed environment for any wiring, instrumentation or the like used with the fixtures 104.

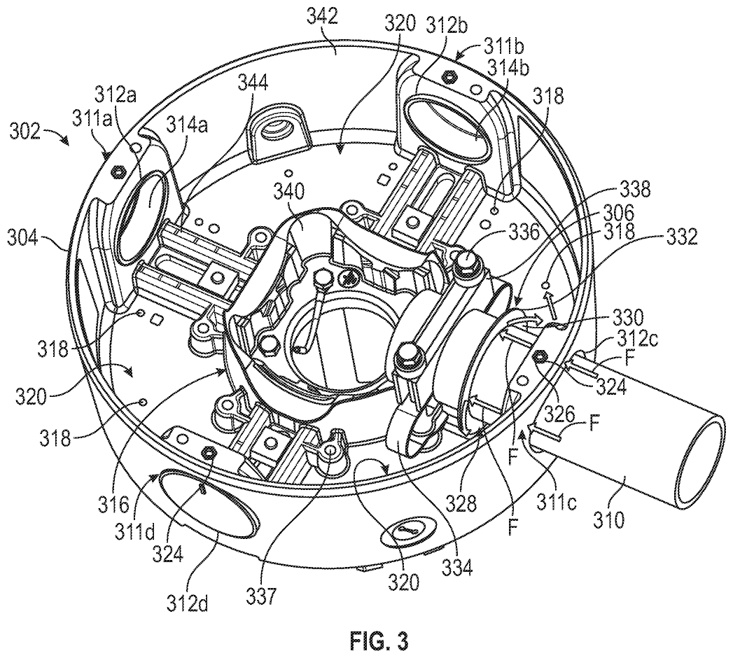

FIG. 3 is an interior view of another example of a liquid diverting fixture assembly 300. The liquid diverting fixture assembly 300 can include a housing 304, a diversion skirt 306, a support bracket 308, and a tenon 310. The housing 304 can include fixture mounts 311a-311d (including tenon orifices 312a-312d surrounded by orifices walls 314a-314d), an isolation flange 316, drains 318, drain reservoirs 320, fixture fastener bores 324, fixture fasteners 326, and liquid diverting assemblies 328. The liquid diverting assemblies 328 can include the diversion skirt 306, the drains 318, the drain reservoirs 320, and other components of the housing 304. The ring diverter 306 can include a diversion skirt 330 and a skirt perimeter 332 shown proximate to the exterior of the tenon 310 in FIG. 3. The support bracket 308 includes one or more jaws, such as a bottom biasing element 334, fasteners 336, and a top jaw 338. Also shown in FIG. 3 are fluid flow path arrows F and area C indicating a zone within the assembly 300 configured to house sensitive components, such as electrical components.

The housing 304 can be a rigid or semi-rigid member comprised of materials such as one or more of metals, plastics, foams, elastomers, ceramics, composites, combinations thereof, or the like. The housing 304 receives the tenons 310 and is configured for connection to a work piece such as the support 106 (e.g., a pole, post, or the like). In another example, the housing 304 encloses and protects sensitive components (such as electrical components) therein, as discussed in further detail below.

The fixture mounts 311a-311d are, in one example, configured to receive tenons, such as the tenon 310. The tenon orifices 312a-312d (collectively referred to as orifices 312) can be defined by the orifice walls 314a-314d (collectively referred to as orifice walls 314). The orifice walls 314 receive and support a tenon (such as the tenon 310) therein and fixture fasteners 326, such as set screws or the like, are positioned within fixture fastener bores 324 to engage the tenon 310 and secure the tenon 310 within the fixture mounts 311a-311d and therefore to the housing 304.

In another example, an isolation flange 316 is positioned within the housing 304. Optionally, the isolation flange 316 supports one or more of the tenons 310. For example, the isolation flange 316 acts as a component of a bottom jaw to support one or more tenons. Optionally, the isolation flange isolates components of the fixture 302 from the drain reservoir 320. In some examples, the isolation flange 316 includes a flange wall 340 that can be coincident to at least a portion of the one or more ring diverters 330 to enhance the interception of liquid that incidentally enters the assembly. Optionally, the isolation flange 316 overlaps and is staggered relative to at least a portion of the ring diverters 330 and/or the diversion skirt 306 to further enhance interception of incoming liquid.

The example support bracket 308 shown in FIG. 3 secures the tenon 310 to the housing 304. In this example, a portion of the isolation flange 316 and the top jaw 338 together receive and engage the tenon 310. The fasteners 336 extend between the top jaw 338 and biasing element 334 and are received within bracket bores 337 to secure the bracket 308 and the tenon 310 to the housing 304. In some examples, a biasing element 337, such as a spring or other elastomeric element, can coupled with the support bracket 308 (e.g., between the top and bottom jaws). In either example, the biasing element 334 or the biasing element 337 is configured to bias jaws apart for ease of service. In another example, rotation of the fasteners 336 overcomes the bias of the biasing element 334 and in turn brings the jaws together to secure the tenon in place.

Drains 318 are shown in the example provided in FIG. 3. In this example, the drains 318 include holes, ports or bores within and extending through a bottom wall of the housing 304. In this example, the drains 318 are positioned within the drain reservoirs 320. The drain reservoirs 320 are isolated from the remainder of the assembly in the example shown by the flange wall 340 of the isolation flange 316, external walls 342 of the housing 304, and internal walls 344 of the housing 304. The drain reservoirs 320 are optionally shallow reservoirs or recessed portions of the housing 304 configured to receive and direct fluid entering the housing 304 to the drains 318 for direction of the fluid out of the housing 304. Further operation of these components is discussed below.

The ring diverter 306 extends around the tenon 310 (including surrounding and partially surrounding the tenon) within the housing 304. The diversion skirt 330 in one example is a portion of the diverter 306 extending laterally or radially out from the tenon 310. The diversion skirt 330 is configured to direct fluid away from the tenon (e.g., deflect, guide or the like) proximate to the support bracket 308 for instance into the drain reservoirs 320 to minimize inward fluid movement into the housing along the tenon 310.

In operation, the example liquid diverting assemblies direct fluid incidentally received in the housing 304 into the reservoirs 320 for draining. For example, when the tenons 310 are secured to the housing 304 (such as by the support brackets 318) the diversion skirt 306 extends along the tenon 310 within the housing 304. During operation, for instance in inclement weather, incidental moisture is received in the housing 304, such as by wind-driven rain, vapor, humidity or the like. The incidental moisture passes between the tenon 310 and the orifice wall 314 as shown by the fluid path F in FIG. 3. The diversion skirt 330 of the ring diverter 306 is coincident with the fluid path F between the tenon and wall and intercepts the moisture that enters the housing 304. The ring diverter 306 including the diversion skirt 330 directs the moisture generally outward and downward (because of the gravity) from the tenon 310. In some examples, the moisture is directed along the skirt perimeter 332 in a similar manner to interception and direction along the ring diverter 306. Accordingly, the remainder of the tenon 310 (e.g., distal to the orifice wall 314 and the point of ingress) and interior sensitive components surrounded by the isolation flange 316 are isolated from further ingressing moisture.

Optionally, the ring diverter 306 directs the fluid incident against the ring diverter, such as moisture toward the reservoirs 340. Direction of moisture into the reservoirs 340 isolates the moisture therein and minimizes infiltration of moisture into other sensitive areas of the assembly, such as the sensitive component area C by the flange wall 340 and the internal walls 344 of the housing 304 while the external walls 342 of the housing 304 can help limit fluid ingress.

As fluid gathers in the reservoirs 320, the drains 318 gradually divert the fluid (e.g., moisture) from the reservoirs 320 out of the housing 304 as shown by the fluid flow path F. Optionally, the reservoirs 320 are shaped to direct collected fluid toward the drains 318. For instance, the reservoirs are graded (tapered) toward the drains 318. Accordingly, the liquid diverting assemblies 328 described herein intercept incidentally ingressed liquid such as moisture before it reaches sensitive components. Further, the liquid diverting assemblies 328 direct or route the intercepted liquid to one or more drains 318 that are isolated from the sensitive components thereby protecting the components and minimizing component failure or damage due to ingressed fluid.

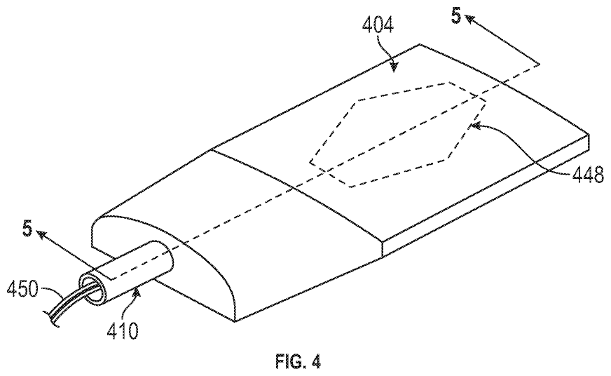

FIG. 4 is a perspective view of a fixture 404 including a tenon 410. The fixture 404 can include a housing 446, a sensitive component 448, the tenon 410, and wiring 450. Components of FIG. 4 having reference numerals similar to those of previous figures can be similar components.

The fixture 404 can generally be a light fixture, an audio fixture, an instrumentation fixture, a sensor fixture, or the like. The housing 446 can be a rigid or semi-rigid member comprised of materials such as one or more of metals, plastics, foams, elastomers, ceramics, composites, combinations thereof, or the like. The housing 406 can be connected to the tenon 410 and configured to support components, such as the sensitive component 408, therein. The sensitive component 408 can include, but are not limited to, wiring, wiring harnesses, cables, lighting elements, instrumentation, other electrical components, or the like. The wiring 450 can be conduit or wiring connected to the sensitive component 408 and routed through the housing 406 and the tenon 410. The wiring 450 can be further routed through a housing, such as the housing 304 of the liquid diverting fixture assembly 302 of FIG. 3.

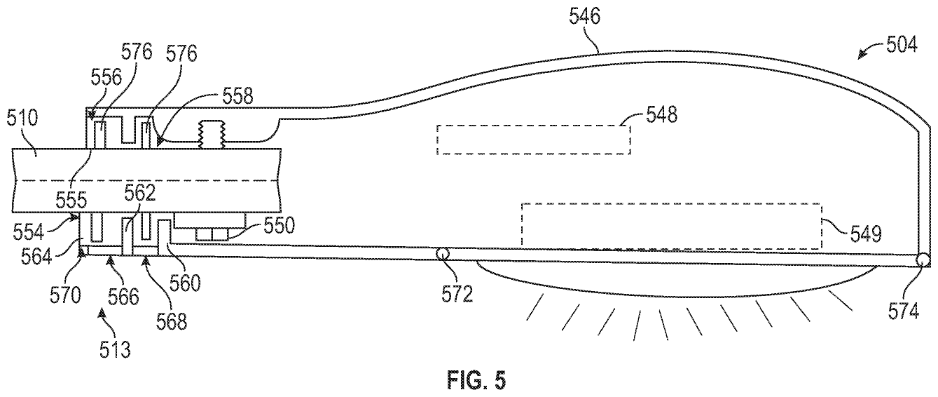

FIG. 5 is a cross sectional view of an example fixture 504 across indicators 5-5 of FIG. 4, where the fixture 504 optionally includes a liquid diverting fixture assembly 513. The fixture 504 can also include a housing 546, sensitive components 548 and 549, a tenon 510, and a set fastener 550. The housing 546 can include a tenon orifice 554, an orifice wall 555, diverter recesses 556 and 558, isolation flanges 560 and 562, a drain reservoir 564, drains 566 and 568, and housing joints 570, 572, and 574. The liquid diverting assembly 513 can include ring diverters 576 and the liquid diverting assembly 513 can include portions of the housing, such as the diverter recess 556, the diverter recess 558, the isolation flange 560, the isolation flange 562, the drain reservoir 564, and the drains 566 and 568. Components of FIG. 5 having reference numerals similar to those of previous figures can be similar components.

Optionally, the sensitive components 548 and 549 include, but are not limited to, wiring, wiring harnesses, cables, lighting elements, instrumentation, other electrical components, or the like. The housing 546, optionally, is a housing similar to the housing 446 that is configured to enclose and support one or more of the sensitive components 548 and 549. The housing 546 is configured to receive the tenon 510 therein through the tenon orifice 554 where the tenon 510 can be secured to the housing 546 using the set fastener 550, in one example. The tenon orifice 554 can have different shapes configured to receive tenons 510 of different profiles, such as circular and non-circular shapes (e.g., square, oval, rectangular) and different sizes.

The liquid diverting assembly 513 is optionally one or more components of the housing 546 (and the ring diverter(s) 576) configured to intercept liquid that enters the housing 546. For example, the diverter recess 556 and the diverter recess 558 are recesses formed by walls of the housing 546, the isolation flange 560, and the isolation flange 562. The isolation flange 560 can be a flange coincident to at least a portion of one or more of the ring diverters 576 to enhance the interception of ingressing liquid. The isolation flange 560 can overlap and can be staggered relative to at least a portion of the ring diverters/diversion skirt 576 such as to form a labyrinth seal between the tenon 510, the ring diverters 576, and the housing 546. In some examples, isolation flange 560 (and optionally 562) are positioned between the sensitive components 548/549 and the drain(s) 566 (568).

Optionally, one or more of the diverter recess 556 and the diverter recess 558 form a portion of the drain reservoir 564. In some examples, the recesses extend between a proximal end of the housing 546 and the isolation flange 560. Also, each of the diverter recess 556 and the diverter recess 558 are optionally sized to allow for the ring diverters 576 to be placed along or optionally around a portion the tenon 510.

In an example, the drains 566 and 568 are be holes or bores in the housing 546 that are positioned in the drain reservoir 564. In some examples, the drain 566 is positioned in the diverter recess 556 and the drain 568 is positioned in the diverter recess 558. The housing 546 optionally includes one drain or several drains, such as 2, 3, 4, 5, 6, 7, 8, 9, 10, 15, 20, 30, 40, 50, 100 or the like.

Optionally, one or more of the housing joints 570, 572, and 574 are portions of the housing 546 at which the housing can flex, bend, rotate, or the like. In one example, one or more of the joints 570, 572, and 574 include a hinge that supports opening of the fixture housing 546 to access the components, such as the sensitive components 548, of the fixture 504. In some examples, the joints 570, 572, and 574 allow for access to one or more of the diverter recess 556 and the diverter recess 558. In some examples, the housing joints 570, 572, and/or 574 allow for positioning of the fixture 504 or a portion of the fixture 504 relative to another portion of the fixture 504.

The ring diverters 576 are optionally rings, collars, skirts, or dividers. One or more of the ring diverters are optionally configured to engage and extend along (or optionally at least partially surround) a portion or more (such as a circumference) of the tenon 510. Optionally, one or more of the ring diverters 576 are configured to intercept liquid and divert the liquid before ingress to sensitive components of the fixture 504. In an example, the ring diverter 576 can be coincident with the tenon orifice 554 to help minimize (e.g., reduce or eliminate) ingress of liquid. In another example, the ring diverter 576 is coincident with one or more features, such as one or more isolation flanges, such as the flange 560, to enhance prevention of ingress (e.g., with a tortuous or serpentine path through the ring diverter and the isolation flange before the sensitive components 548 and 549). Optionally, the ring diverter is at least partially aligned with one or more of the tenon orifice 554, the isolation flanges 560 and 562, or the like to block the ingress of moisture, particulate matter, or the like.

In some examples, wind-driven rain, or other moisture, may pass between the tenon orifice 554 and the tenon 510. A portion of such moisture engages the first ring diverter 576, which diverts the liquid down to the drain reservoir 564 for draining from the housing 546 through the drain 566. A portion of the liquid that continues past the diverter 576 engages the isolation flange(s) 562 and is redirected into the drain reservoir 564 for draining through the drain 566. A portion of the liquid that continues past the isolation flange(s) 562 engages and is redirected by the second ring diverter 576 into the drain reservoir 564 for draining through the drain 568. A portion of the liquid that continues past the second ring diverter 576 can engage and be redirected by the isolation flanges 562 into the drain reservoir 564 for draining through the drain 568. In an example, together, the ring diverters 576 and the isolation flanges 560 and 562 create a labyrinth seal around the tenon 510 to limit fluid ingress while the drain reservoir 564 and the drains 566 and 568 collect and expel any liquid deflected or intercepted by the seal(s). Such obstacles to fluid intake can help prevent ingress of fluid to the sensitive components 548 and 549, helping to increase component operation life.

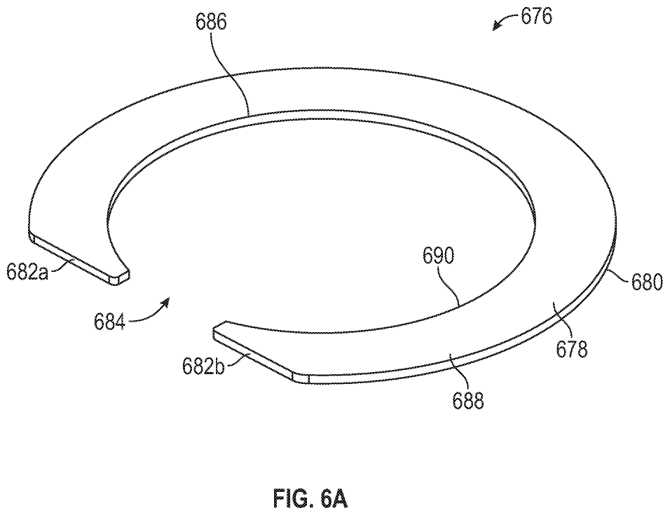

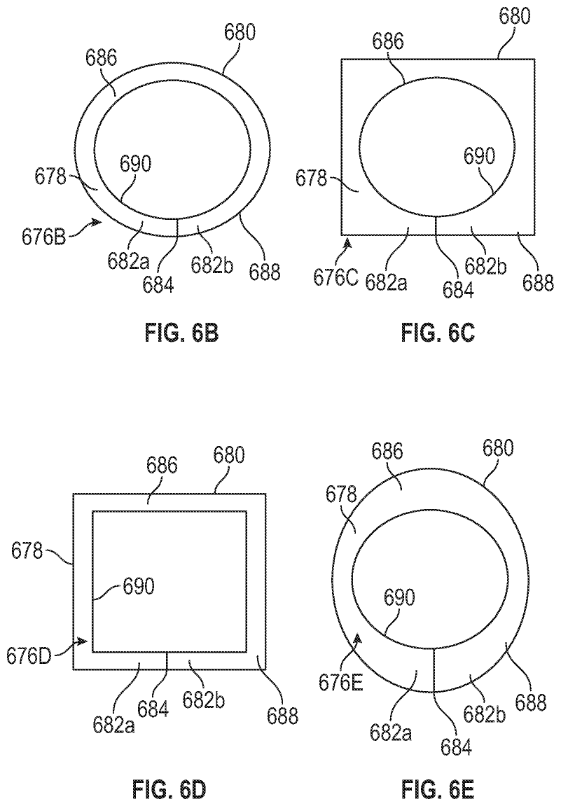

FIG. 6A is a perspective view of an example ring diverter 676. The ring diverter 676 optionally includes a diversion skirt 678, a skirt perimeter 680, drain reservoir ends 682a and 682b (defining the installation gap 684), an engagement collar 686, an outer edge 688, and an inner edge 690.

In an example, the ring diverter 676 is a semi-rigid member comprised of materials such as one or more of metals, plastics, foams, elastomers, ceramics, composites, combinations thereof, or the like. The diversion skirt 678 optionally has a thickness sized to promote engagement with fluid bypassing a tenon.

In one example, the ring diverter 676 is constructed with an elastic material (e.g., polymers, metals or the like) configured to deflect without deforming for coupling around or along a tenon (e.g., of a light fixture, or other device). The ring diverter 676 optionally elastically engages the tenon with the engagement collar 686 such that the engagement collar 686 engages at least a portion of a perimeter of the tenon. In some examples, the engagement collar 686 is configured for flush engagement around the tenon 610. Accordingly, in some examples, the engagement collar 686 includes a collar shape corresponding to a tenon shape of the tenon (such as the tenon 510), where the tenon shape can be square, rectangular, oval, circular, or the like.

In an example, the installation gap 684 facilitates installation of the ring 676 around a tenon or other component (e.g., through deflection of the ring diverter). The installation gap 684 can be optional. In examples without the installation gap 684, the ring diverter 676 slidably couples around the tenon (e.g., a component) at the tenon end and slides to the specified position.

FIGS. 6B-6E are top views of example ring diverters having different profiles. FIG. 6B shows an example where a ring diverter 676B has a substantially circular cross-section including a circular outer edge 688 and a circular inner edge 690 and therefore a circular skirt perimeter 678 with an installation gap 684. FIG. 6C shows an example where a ring diverter 676C has a square or rectangular outer edge 688 and a circular inner edge 690 and therefore an irregularly shaped skirt perimeter 678 with an installation gap 684. FIG. 6D shows an example where a ring diverter 676D includes a square or rectangular outer edge 688 and a square or rectangular inner edge 690 and therefore a square or rectangular skirt perimeter 678 with an installation gap 684. FIG. 6E shows an example ring diverter 676E including an oval outer edge 688 and an oval inner edge 690 and therefore an oval-shaped skirt perimeter 678 with an installation gap 684. Though the oval outer edge 688 and the oval inner edge 690 of the ring diverter 676E are of different shapes, the oval outer edge 688 and the oval inner edge 690 can be of the same shape (concentric) in other examples. In any of the examples of FIGS. 6B-6E the installation gap 684 can be omitted.

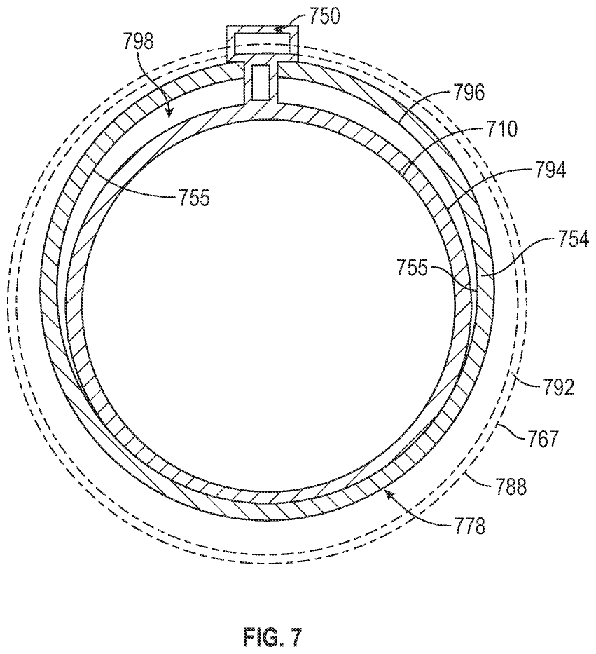

FIG. 7 is a schematic view of an example ring diverter 767 in a coincident position relative to a tenon orifice 754. In an example, a skirt profile 792 includes a shape and size formed by a diversion skirt 778 and a skirt perimeter 788 of the ring diverter 767. The skirt profile 792 can have various shapes and/or sizes in various examples. In an example, the skirt profile 792 extends from the tenon 710 into an intercepting position relative to the tenon orifice 754. In various examples, the skirt profile 792 intercepts liquid and directs liquid to the reservoirs/drains of a fixture.

A tenon profile 794 optionally includes a shape and size (e.g., area) of the tenon cross section. In an example, a tenon orifice profile 796 includes a shape and size (e.g., area) surrounded by the orifice wall 755. A difference profile 798 is a gap, in one example, at least as large as the tenon orifice profile 796 minus the tenon profile 794. In another example, the difference profile 798 is provided between an orifice wall 755 and the tenon 710. In an example, the skirt profile 792 is aligned (including coincident and in an intercepting location) with the difference profile (e.g., gap) 798. The skirt profile 792 is optionally larger than the tenon orifice profile 796 as well. In this way, the skirt 778 helps deflect and divert moisture by having a profile larger than a profile of the tenon 710 and the orifice 754.

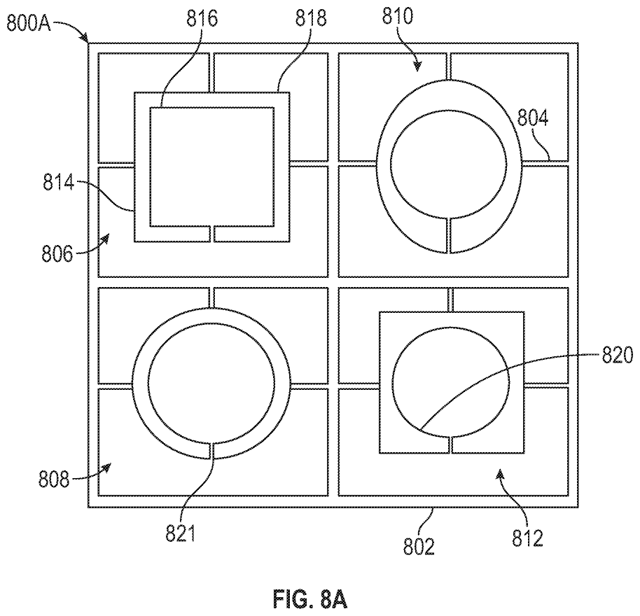

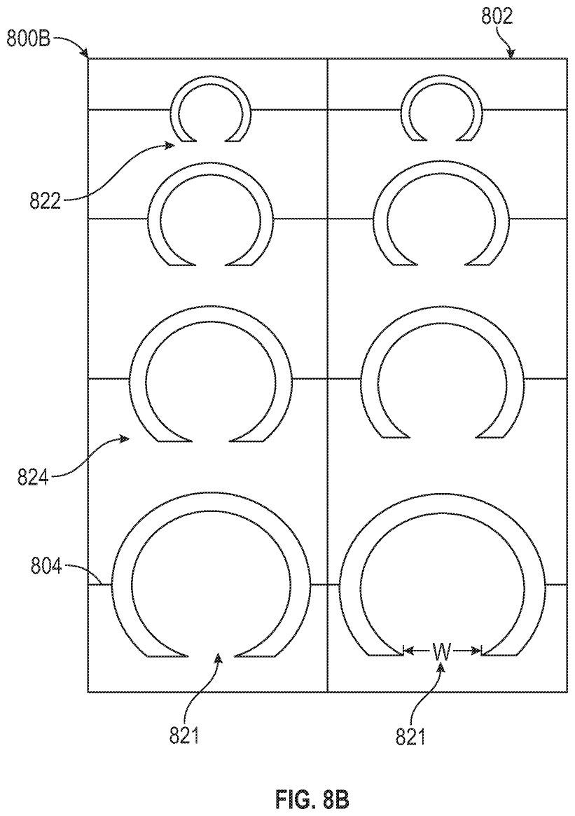

FIG. 8A is a plan view of an example punch out sheet 800A including a plurality of ring diverters. In some examples, each of the ring dividers has different profiles, such as different skirt profiles. The punch out sheet 800A optionally includes a sprue 802 where the sprue 802 provides a frame for the punch out sheet 800A. Optionally, the punch out sheet 800A includes a runner 804 which transitions from the sprue 802 to one or more of the ring dividers of the sheet 800A. In some examples, the punch out sheet includes a first diverter 806, a second diverter 808, a third diverter 810, and a fourth diverter 812.

In an example, the first diverter 806 has a first skirt profile, such as a square or rectangular shaped profile. The first diverter 806 further includes a diversion skirt 814, an engagement collar 816, and a skirt perimeter 818 defining a skirt outer profile. The second diverter 808 optionally has a second skirt profile, such as a circular shape. The third diverter 810 optionally has a third profile such as diverter with a perimeter shape of an oval and a circular collar shape. Each diverter can optionally include an installation gap, such as the installation gap 821. The fourth diverter 812 has a fourth skirt profile, in some examples. In one example, the fourth diverter 812 can have a collar profile 820 of a circle and an outer skirt perimeter or profile of a square or rectangle. Diverters of other shapes can be used and sheets including varying shapes and/or sizes can be used.

FIG. 8B is a plan view another example of a punch out sheet 800B including a plurality of ring diverters with different profiles, such as different skirt sizes. The punch out sheet 800B optionally includes a sprue 802 where the sprue 802 provides a frame for the punch out sheet 800B. In an example, the punch out sheet 800B includes a runner 804 which can transition from the sprue 802 to one or more of the ring dividers of the sheet 800B. Each diverter can optionally include an installation gap, such as the installation gap 821. In some examples, a width W of the installation gap 821 is varied (e.g., configured) to accommodate components of the liquid diverting fixture assembly (such as a dimension of a tenon).

In an example, a first ring diverter 822 has a first skirt profile, such as a horseshoe profile at a first size. The first size, optionally, is a relatively small size for a first tenon size. In the same or different example, a second ring diverter 822 has a second skirt profile, such as a relatively larger horseshoe profile for a second tenon size. In some examples, the punch out sheet 800B includes ring diverters with varying sizes (i.e., varying dimensions).

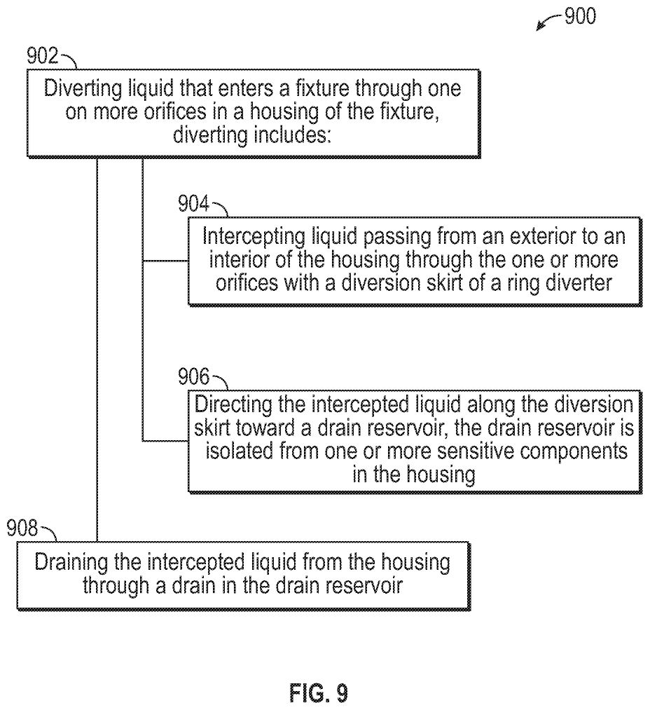

FIG. 9 is a block diagram of an example method 900. The method 900 is an example of a method of managing liquid ingression in a fixture, such as into the fixture 102 discussed above with respect to FIGS. 1-3. More specific examples of the method 900 are discussed below. The steps or operations of the method 900 are illustrated in a particular order for convenience and clarity; many of the discussed operations can be performed in a different sequence or in parallel without materially impacting other operations. The method 900 as discussed includes operations performed by multiple different actors, devices, and/or systems. It is understood that subsets of the operations discussed in the method 900 can be attributable to a single actor, device, or system could be considered a separate standalone process or method.

An example method for managing liquid ingression in a fixture begin at step 902, where liquid that enters the fixture 504 through one or more orifices 554 in the housing 546 of the fixture 504 is diverted. In some examples, at step 904, diverting the liquid includes intercepting liquid passing from an exterior to an interior of the housing 546 through the one or more orifices 554 with a diversion skirt 678 of a ring diverter 676.

In some examples, at step 906, diverting the liquid includes directing the intercepted liquid along the diversion skirt 676 toward the drain reservoir 564, where the drain reservoir 564 is optionally isolated from one or more sensitive components 548 in the housing 546. In an example of step 908, the intercepted liquid is drained from the housing 546 through the drain 566 in the drain reservoir 564.

In another example, the orifices 554 include the orifice wall 555 that extends around the tenon 510. Then, liquid passing from the exterior to the interior is intercepted the diversion skirt 678 between the tenon 510 and the orifice wall 555.

In another example, diverting liquid includes intercepting liquid passing from the exterior to the interior of the one or more orifices 554 with the isolation flange 562, where the isolation flange is coincident with at least a portion of the diversion skirt 678.

In another example, diverting liquid includes intercepting liquid passing from the exterior to the interior of the orifice 554 with the isolation flange 562, where the isolation flange is overlapping and staggered relative to at least a portion of the diversion skirt 678. In another example, directing the intercept liquid includes directing the intercepted liquid by gravity along the diversion skirt 678 toward the drain reservoir 564. In another example, diverting liquid includes occluding the orifice 554 with the ring diverter 576. In another example, diverting liquid includes interposing the ring diverter 576 between the orifice 554 and the sensitive components 548 and/or 549.

### Various Notes & Examples

Aspect 1 may include or use subject matter (such as an apparatus, a system, a device, a method, a means for performing acts, or a device readable medium including instructions that, when performed by the device, may cause the device to perform acts, or an article of manufacture), such as may include or use a liquid diverting fixture assembly comprising: a housing including one or more sensitive components therein; at least one tenon orifice extending through the housing, the tenon orifice configured for reception of a tenon therein; and a liquid diverting system within the housing, the liquid diverting system includes: a ring diverter configured for coupling along the tenon and positioning between the at least one tenon orifice and the one or more sensitive components, the ring diverter includes a diversion skirt having a skirt profile coincident to at least the tenon orifice, a drain reservoir recessed from the one or more sensitive components, and the diversion skirt extends toward the drain reservoir, and a drain in communication with the drain reservoir.

Aspect 2 may include or use, or may optionally be combined with the subject matter of Aspect 1, to optionally include or use wherein the at least one tenon orifice includes a set fastener configured for engagement with the tenon.

Aspect 3 may include or use, or may optionally be combined with the subject matter of one or any combination of Aspects 1 or 2 to optionally include or use wherein the tenon includes a tenon profile smaller than a tenon orifice profile of the at least one tenon orifice.

Aspect 4 may include or use, or may optionally be combined with the subject matter of Aspect 3 to optionally include or use wherein a difference profile is at least the tenon orifice profile minus the tenon profile, and the skirt profile is at least as large as the difference profile.

Aspect 5 may include or use, or may optionally be combined with the subject matter of one or any combination of Aspects 3 or 4 to optionally include or use wherein a difference profile is between the tenon and an orifice wall of the at least one tenon orifice, and the skirt profile is coincident with the difference profile.

Aspect 6 may include or use, or may optionally be combined with the subject matter of one or any combination of Aspects 3 through 5 to optionally include or use wherein the housing includes an isolating flange between the sensitive components and the drain, and the skirt profile is coincident with the isolating flange.

Aspect 7 may include or use, or may optionally be combined with the subject matter of one or any combination of Aspects 1 through 6 to optionally include or use wherein the housing includes a fixture mount housing configured for mounting one or more fixture assemblies.

Aspect 8 may include or use, or may optionally be combined with the subject matter of one or any combination of Aspects 1 through 7 to optionally include or use wherein the housing includes a fixture housing with a fixture element therein.

Aspect 9 may include or use, or may optionally be combined with the subject matter of one or any combination of Aspects 1 through 8 to optionally include or use wherein the drain reservoir and the drain are isolated from the one or more sensitive components with the ring diverter.

Aspect 10 may include or use, or may optionally be combined with the subject matter of one or any combination of Aspects 1 through 9 to optionally include or use wherein the drain reservoir and the drain are isolated from the sensitive components with the ring diverter and at least one flange of the housing.

Aspect 11 may include or use subject matter (such as an apparatus, a system, a device, a method, a means for performing acts, or a device readable medium including instructions that, when performed by the device, may cause the device to perform acts, or an article of manufacture), such as may include or use a ring diverter comprising: a diversion skirt configured for coupling with a tenon of a fixture, the diversion skirt includes: a skirt perimeter at an outer edge of the diversion skirt, an engagement collar at an inner edge of the diversion skirt, the engagement collar configured for engagement around the tenon.

Aspect 12 may include or use, or may optionally be combined with the subject matter of Aspect 11, to optionally include or use wherein the engagement collar is configured for flush engagement around the tenon.

Aspect 13 may include or use, or may optionally be combined with the subject matter of one or any combination of Aspects 11 or 12 to optionally include or use wherein the engagement collar includes a collar shape corresponding to a tenon shape of the tenon.

Aspect 14 may include or use, or may optionally be combined with the subject matter of Aspect 13 to optionally include or use wherein the engagement collar includes a collar shape including at least one of a circle, oval, ellipse, triangle, rectangle or square.

Aspect 15 may include or use, or may optionally be combined with the subject matter of one or any combination of Aspects 11 through 14 to optionally include or use wherein the diversion skirt includes a skirt profile extending away from the engagement collar.

Aspect 16 may include or use, or may optionally be combined with the subject matter of Aspect 15 to optionally include or use wherein the diversion skirt is configured to extend away from the tenon.

Aspect 17 may include or use, or may optionally be combined with the subject matter of one or any combination of Aspects 11 through 16 to optionally include or use wherein the diversion skirt is constructed with a polymer configured for deflection around the tenon during installation.

Aspect 18 may include or use, or may optionally be combined with the subject matter of one or any combination of Aspects 11 through 17 to optionally include or use a diverter sheet including a plurality of ring diverters having one or more skirt profiles thereon.

Aspect 19 may include or use, or may optionally be combined with the subject matter of one or any combination of Aspects 11 through 18 to optionally include or use the tenon.

Aspect 20 may include or use, or may optionally be combined with the subject matter of one or any combination of Aspects 11 through 19 to optionally include or use a housing having at least one tenon orifice extending through the housing, the tenon orifice configured for reception of the tenon therein; and wherein the diversion skirt is coincident with an interface between the tenon and an orifice wall of the tenon orifice.

Aspect 21 may include or use, or may optionally be combined with the subject matter of one or any combination of Aspects 11 through 20 to optionally include or use wherein the diversion skirt is coupled with the tenon at the exterior of the housing and proximate to the interface.

Aspect 22 may include or use, or may optionally be combined with the subject matter of one or any combination of Aspects 11 through 21 to optionally include or use at least one drain in communication with the diversion skirt.

Aspect 23 may include or use, or may optionally be combined with the subject matter of Aspect 22 to optionally include or use a drain reservoir including the at least one drain, and the diversion skirt is in communication with the drain reservoir.

Aspect 24 may include or use subject matter (such as an apparatus, a system, a device, a method, a means for performing acts, or a device readable medium including instructions that, when performed by the device, may cause the device to perform acts, or an article of manufacture), such as may include or use a method for managing liquid ingression in a fixture comprising: diverting liquid that enters a fixture through one or more orifices in a housing of the fixture, diverting includes: intercepting liquid passing from an exterior to an interior of an the housing through the one or more orifices with a diversion skirt of a ring diverter, and directing the intercepted liquid along the diversion skirt toward a drain reservoir, the drain reservoir is isolated from one or more sensitive components in the housing; and draining the intercepted liquid from the housing through a drain in the drain reservoir.

Aspect 25 may include or use, or may optionally be combined with the subject matter of Aspect 24, to optionally include or use wherein the one or more orifices includes an orifice wall extending around a tenon, and intercepting liquid passing from the exterior to the interior includes intercepting liquid on the diversion skirt between the tenon and the orifice wall.

Aspect 26 may include or use, or may optionally be combined with the subject matter of one or any combination of Aspects 24 or 25 to optionally include or use wherein diverting liquid includes intercepting liquid passing from the exterior to the interior of the one or more orifices with an isolation flange, the isolation flange coincident with at least a portion of the diversion skirt.

Aspect 27 may include or use, or may optionally be combined with the subject matter of one or any combination of Aspects 24 through 26 to optionally include or use wherein diverting liquid includes intercepting liquid passing from the exterior to the interior of the one or more orifices with an isolation flange, the isolation flange overlapping and staggered relative to at least a portion of the diversion skirt.

Aspect 28 may include or use, or may optionally be combined with the subject matter of one or any combination of Aspects 24 through 27 to optionally include or use wherein directing the intercept liquid includes directing the intercepted liquid by gravity along the diversion skirt toward the drain reservoir.

Aspect 29 may include or use, or may optionally be combined with the subject matter of one or any combination of Aspects 24 through 28 to optionally include or use wherein diverting liquid includes occluding the orifice with the ring diverter.

Aspect 30 may include or use, or may optionally be combined with the subject matter of one or any combination of Aspects 24 through 29 to optionally include or use wherein diverting liquid includes interposing the ring diverter between the orifice and the sensitive components.

Aspect 31 may include or use, or may optionally be combined with any portion or combination of any portions of any one or more of Aspects 1 through 30 to include or use, subject matter that may include means for performing any one or more of the functions of Aspects 1 through 30.

Each of these non-limiting aspects can stand on its own, or can be combined in various permutations or combinations with one or more of the other aspects.

The above detailed description includes references to the accompanying drawings, which form a part of the detailed description. The drawings show, by way of illustration, specific embodiments in which the disclosure can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

1. A liquid diverting fixture assembly comprising:
a housing including one or more sensitive components therein;
at least one tenon orifice extending through the housing, the tenon orifice configured for reception of a tenon therein; and
a liquid diverting system within the housing, the liquid diverting system includes:
a ring diverter configured for coupling along the tenon and positioning between the at least one tenon orifice and the one or more sensitive components, the ring diverter includes a diversion skirt having a skirt profile coincident to at least the tenon orifice;
a drain reservoir recessed from the one or more sensitive components, and the diversion skirt extends toward the drain reservoir; and
a drain in communication with the drain reservoir.

2. The assembly of claim 1, wherein the at least one tenon orifice includes a set fastener configured for engagement with the tenon.

3. The assembly of claim 1, wherein the tenon includes a tenon profile smaller than a tenon orifice profile of the at least one tenon orifice.

4. The assembly of claim 3, wherein a difference profile is at least the tenon orifice profile minus the tenon profile, and the skirt profile is at least as large as the difference profile.

5. The assembly of claim 3, wherein a difference profile is between the tenon and an orifice wall of the at least one tenon orifice, and the skirt profile is coincident with the difference profile.

6. The assembly of claim, 5, wherein the housing includes an isolating flange between the sensitive components and the drain, and the skirt profile is coincident with the isolating flange.

7. The assembly of claim 1, wherein the housing includes a fixture mount housing configured for mounting one or more fixture assemblies.

8. The assembly of claim 1, wherein the housing includes a fixture housing with a fixture element therein.

9. The assembly of claim 1, wherein the drain reservoir and the drain are isolated from the one or more sensitive components with the ring diverter.

10. The assembly of claim 1, wherein the drain reservoir and the drain are isolated from the sensitive components with the ring diverter and at least one flange of the housing.

11. A ring diverter comprising:
a diversion skirt configured for coupling with a tenon of a fixture, the diversion skirt includes:
a skirt perimeter at an outer edge of the diversion skirt; and
an engagement collar at an inner edge of the diversion skirt, the engagement collar configured for engagement around the tenon.

12. The ring diverter of claim 11, wherein the engagement collar is configured for flush engagement around the tenon.

13. The ring diverter of claim 11, wherein the engagement collar includes a collar shape corresponding to a tenon shape of the tenon.

14. The ring diverter of claim 13, wherein the engagement collar includes a collar shape including at least one of a circle, oval, ellipse, triangle, rectangle or square.

15. The ring diverter of claim 11, wherein the diversion skirt includes a skirt profile extending away from the engagement collar.

16. The ring diverter of claim 15, wherein the diversion skirt is configured to extend away from the tenon.

17. The ring diverter of claim 11, wherein the diversion skirt is constructed with a polymer configured for deflection around the tenon during installation.

18. The ring diverter of claim 11, further comprising a diverter sheet including a plurality of ring diverters having one or more skirt profiles thereon.

19. The ring diverter of claim 11, further comprising the tenon.

20. The ring diverter of claim 11, further comprising a housing having at least one tenon orifice extending through the housing, the tenon orifice configured for reception of the tenon therein; and
wherein the diversion skirt is coincident with an interface between the tenon and an orifice wall of the tenon orifice.

21-30. (canceled)
